(19) United States
(12) Patent Application Publication
(10) Pub. No.: US 2008/0109326 A1
(43) Pub. Date: May 8, 2008

(54) Special occasion gift ordering business method - "Remember Easy"

(76) Inventor: William A. Meredith, Hartford City, IN (US)

Correspondence Address: RITCHISON LAW OFFICES, PC;John D. Ritchison, Suite A, 115 East Ninth Street, Anderson, IN, 46016-1509, US

(21) Appl. No.: 11/981,902

(22) Filed: Nov. 1, 2007

Related U.S. Application Data
(60) Provisional application No. 60/856,137, filed on Nov. 2, 2006.

(51) Int. Cl. G06Q 30/00

(52) U.S. Cl. 705/26

(57) ABSTRACT

A business method process of combining a computer assisted display of gifts, choosing a gift, directing the gift to be provided, and then purchasing the gift for future delivery. The method provides a system that takes the selection from the purchaser, receives a payment, schedules a delivery of the gift, and confirms the entire transaction for the purchaser. The method provides a unique and simple way for a purchaser to order a service of providing a product to recognize a special occasion, to order and pay for a said product, to deliver the said product, and to feedback the order and delivery to the purchasing client. The method provides a way to combine various existing systems and websites with simple, new way to accomplish concrete, useful and tangible results in improvement of the gift providing industry.

### CROSS-REFERENCE TO RELATED APPLICATIONS

This application claims the benefit of Provisional Patent Application Ser. No. 60/856,137 filed Nov. 2, 2006 by William Meredith, and titled Special Occasion Gift Ordering Business Method—“Remember Easy”.

### FIELD OF INVENTION

This present improvement invention relates to A BUSINESS METHOD in gift services and special occasion management. Specifically, this new method relates to “Remembering and Acting” on providing gifts to special persons, friends, and relatives on specific and special dates such as birthdays, anniversaries, and other renowned dates and special occasions. The method provides a unique way to provide a “giver/member/client” a system that is a method of combining a computer assisted implementation of displaying optional gifts, choosing an optional gift group or specific gift, directing the gift to be provided, and then purchasing the gift for future delivery. It also provides a system that takes the selection from the purchaser, receives a payment, schedules a delivery of the gift, and confirms the entire transaction for the purchaser. The method provides a unique and simple way for a purchaser to order a service of providing a product to recognize a special occasion, to order and pay for a said product, to deliver the said product, and to feedback the order and delivery to the purchasing client. The method provides a way to combine various existing systems and websites with simple, new way to accomplish concrete, useful and tangible results in improvement of the gift providing industry.

### FEDERALLY SPONSORED RESEARCH

None.

### SEQUENCE LISTING OR PROGRAM

None.

### BACKGROUND

### Field of Invention

The new “Remember Easy” is a method used in the gift business for providing presents, services and special occasion event management. Specifically, this new method relates to “Remembering and Acting” on providing gifts to special persons, friends, and relatives on specific and special dates such as birthdays, anniversaries, and other renowned dates and special occasions. The method provides a unique way to provide a “giver/member/client” a system that is a method of combining a computer assisted implementation of displaying optional gifts, choosing an optional gift group or specific gift, directing the gift to be provided, and then purchasing the gift for future delivery.

A. Introduction of the Problems Addressed:

An easy and simple way to provide special gifts to people on time and accurately is a desired system. In this busy world with handheld personal digital assistants (PDAs), cellular telephones, and electronic scheduling, the important and timely planning and action on the part of close family members, relatives and special persons often gets “lost” in the busy hassle of business and daily life schedules. The Special Occasion Gift Ordering Business Method—“Remember Easy” addresses these shortfalls and provides a unique and tangible solution. The system interfaces and provides an easy system for the member user to schedule gift giving, provides additional revenue for the vendor of gifts, and establishes a way to create a revenue stream to the Special Occasion Gift Ordering Business Method—“Remember Easy” in a tangible and concrete way.

Because of the technology improvements with the internet and other electronic ordering systems, this new combination of systems in a new method provides a desired opportunity to address the needs of the public in “Remembering and Giving” gifts at the desired time.

B. Prior Art:

Historically, gift purchases by some very busy people have often been harried and un-organized. In this fast-paced world, remembering special occasions and acting to provide a memorable gift often came at the last minute with little planning. These hurried acts sometimes resulted in missed occasions or less-than-optimum gift giving. Several methods have attempted to provide a service but have fallen short of the comprehensive and simple system described here for “Remember Easy”.

Examples of modern, computer related prior art methods for gift purchasing and delivering begin with U.S. Pat. No. 5,440,479 issued to Hutton (1995). This taught an apparatus and method for purchasing floral arrangements. It related to a floral kiosk system which interacted with a floral ordering network and allowed users to either select a particular floral arrangement or create a floral arrangement from an assortment of flowers, flower configurations and flower holders. Once the purchase order was completed the system of the present invention interacted with a floral network of providers to complete the transaction. It provided no future interaction to pre-set purchases for special occasions on an ongoing basis and was essentially limited to floral type gifts. Another U.S. Pat. No. 5,971,273 was issued to Vallaire (1999) which showed an automated florist system allowing direct contact with delivering florist. This taught an automated florist system, including an associated cooler and order taking control unit for automated vending and order placements specifically for flowers and gift items. The system, with the control unit was pre-programmed and allowed a walk-up or drive-up customer to select from a variety of pre-made flower arrangements for immediate purchase or for remote delivery at a specified time and place. The operating, host florist of the vending system could remotely monitor and conduct most business with the vending machine from the operating florist's shop. No future reminder system for other special occasions or for more than one person was taught.

Another U.S. Pat. No. 6,094,681 which issued to Shaffer, et al. (2000) demonstrated an apparatus and method for automated event notification. This taught a method and system for automatically providing remote notification of a locally detected event includes receiving data and analyzing the content of the data using a data filter of a computer. The data filter was configured to detect an indication of a predetermined event within the data. If the event is detected, the data filter activated a local event indicator associated with the computer. This system then reminded an individual of an event, but left it to that person to then and there decide whether to act, such as purchase a gift. Again this was a last minute reaction rather than pre-planned recognition of special occasions as taught by Remember Easy. A recent U.S. Patent Application Publication 20020069124 by Alice Hayes, et al. shows an agricultural product business system. Here is described a method and apparatus for distributing agricultural products by selectively distributing orders among a network of agricultural product suppliers. Future selection is not taught nor specificity to different persons.

A U.S. Pat. No. 6,609,106 issued to Robertson (2003) is a system and method for providing electronic multi-merchant gift registry services over a distributed, network. This shows an online Gift Registry Service which provides registration of information for a gift registrant and allows access to the registry by potential gift giver users. It is a pull system from the recipient, not a pre-planned gift from the giver. It provides a checkout process for purchasing these gift items with the registered sites (e.g. World Wide Web sites) over a distributed public network. Users initially register with the Gift Registry Service and are provided additional functionality. A reminder service is provided to notify individuals automatically upon the trigger of certain events, such as important dates or product sales from online merchants. In addition, there are various occasion planning services available such as distribution lists, discussion groups, and other related resources for multiple events including weddings, baby showers, etc. This again is a remind and act system, not a thoughtful preplanned event. Finally, a U.S. Pat. No. 6,980,965 was issued to Alolabi (2005) that teaches a florist registry. Here a coordinated system is provided whereby a registrant may register with a specific merchant or a service which ties a plurality of merchants together. Preferences with the merchant or system are expressed and recorded in the system. Then, as items filling those preferences are purchased, a record is maintained of such purchases, and the orders are filled over a pre-selected period of time. Again, this is a system that teaches a registrant “pulling” gifts from unknown givers, not a thoughtful preplanned gift for various persons on various occasions as shown with the “Remember Easy” method.

As far as known from searches and investigations, there are no business methods at the present time which fully meet this need with as simple of steps as the present Special Occasion Gift Ordering Business Method—“Remember Easy”.

### SUMMARY OF THE INVENTION

This new business method is a Special Occasion Gift Ordering Business Method—“Remember Easy”. The method provides a unique way to provide a “giver/member” a system that is a method of combining a computer assisted implementation of displaying optional gifts, choosing an optional gift group or specific gift, directing the gift to be provided, and then purchasing the gift for future delivery.

The steps comprising this new method and the interface of the method to the member user with the “Remember Easy” system/website which interfaces with the gift vendor provide a complete manner to provide data and a way to enable greatly improved efficiency at ordering gifts for delivery at a predetermined time. The several features provided will be described below in the specification and with the accompanying drawings.

A summary of Key parts in the overall system comprise:
1. A “Remember Easy” website.
2. Pre-established gifts and discounts from various gift vendors.
3. An interface (preferably electronic) from the “Remember Easy” operating system and the vendors order system.
4. Inputs from the member as to personal data, gift recipient information, and gift selection.
5. A payment system from the Member to the “Remember Easy” website.
6. Scheduling the gift by “Remember Easy” with the vendor and payment to the vendor.
7. Follow-up exchanges confirming orders, shipment and delivery by the “Remember Easy” operating system and the vendor ordering system.

### OBJECTS AND ADVANTAGES

Accordingly, there are several objects and advantages of the Special Occasion Gift Ordering Business Method—“Remember Easy”. One advantage of this method is that it facilitates efficient and timely ordering of gifts by a member/user. The gifts are ordered at a convenient time, over the internet, and in a relaxed state for the member to reflect on the special recipients, the occasion and an appropriate gift.

Another advantage is the method removes the fear and consequence of “forgetting” a special occasion. No one is missed and the data base can be used year after year if desired.

A further advantage is the beneficial impact to the user having “one-stop-shopping”. Different gifts are available for different recipients.

Another feature is that the vendor secures an order ahead of time and receives a timely payment from the “Remember Easy” commerce exchange system.

Another advantage is the system permits input by members 24 hours a day, 7 days per week. If the member has time during travel, between meetings, or at night or weekends at his/her residence, the orders may be made . . . on their schedule.

Finally, other advantages and additional features of the present Special Occasion Gift Ordering Business Method—“Remember Easy” will be more apparent from the accompanying drawings and from the full description of the instant improvement method. For one skilled in the art of gift ordering and internet e-commerce systems, it is readily understood that the features shown in the examples with this instant method are readily adapted to other types of improvement methods for other ordering systems and other industries.

### DESCRIPTION OF THE DRAWINGS

### Figures

The accompanying drawings, which are incorporated in and constitute a part of this specification, illustrate an embodiment of the present method that is preferred. The drawings together with the summary description given above and a detailed description given below serve to explain the principles of the Special Occasion Gift Ordering Business Method—“Remember Easy”. It is understood, however, that the Special Occasion Gift Ordering Business Method—“Remember Easy” is not limited to only the precise arrangements and instrumentalities shown.

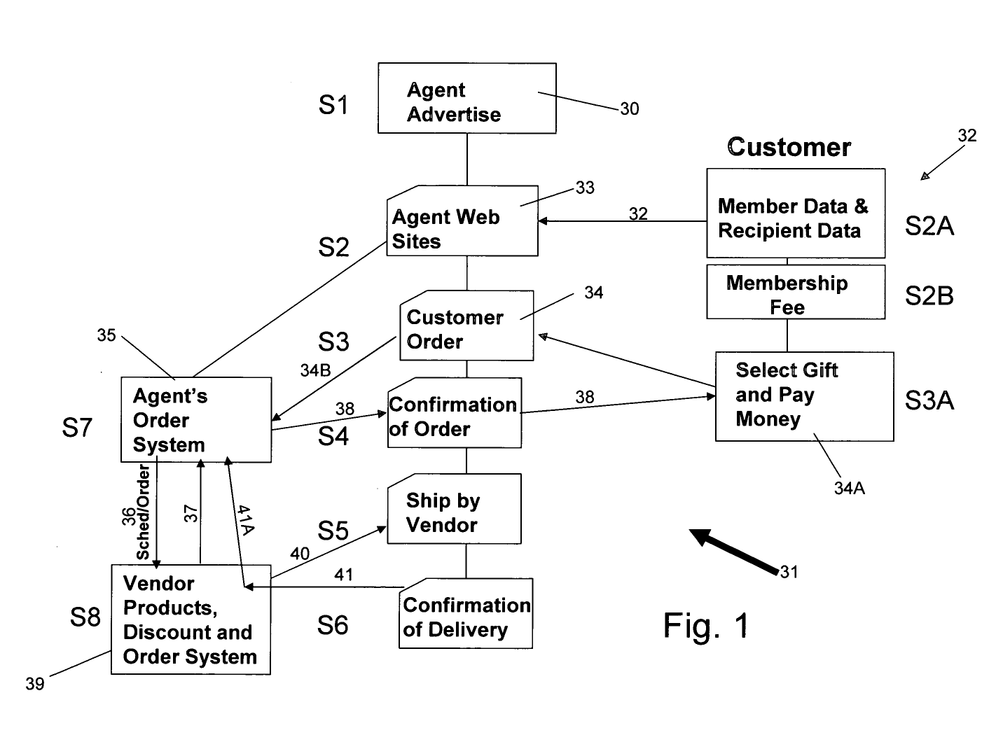

FIG. 1 is a Simple flowchart of the business method.

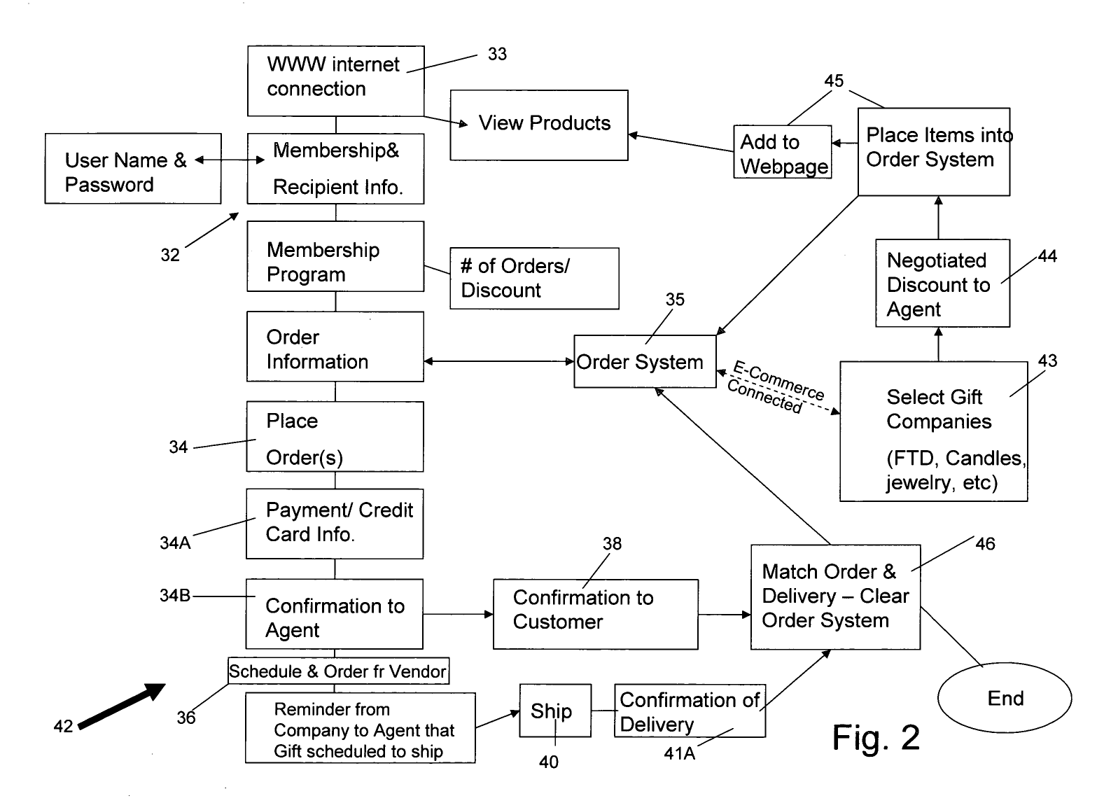

FIG. 2 is a more detailed flowchart showing steps and further details in the business method known as Special Occasion Gift Ordering Business Method—“Remember Easy”.

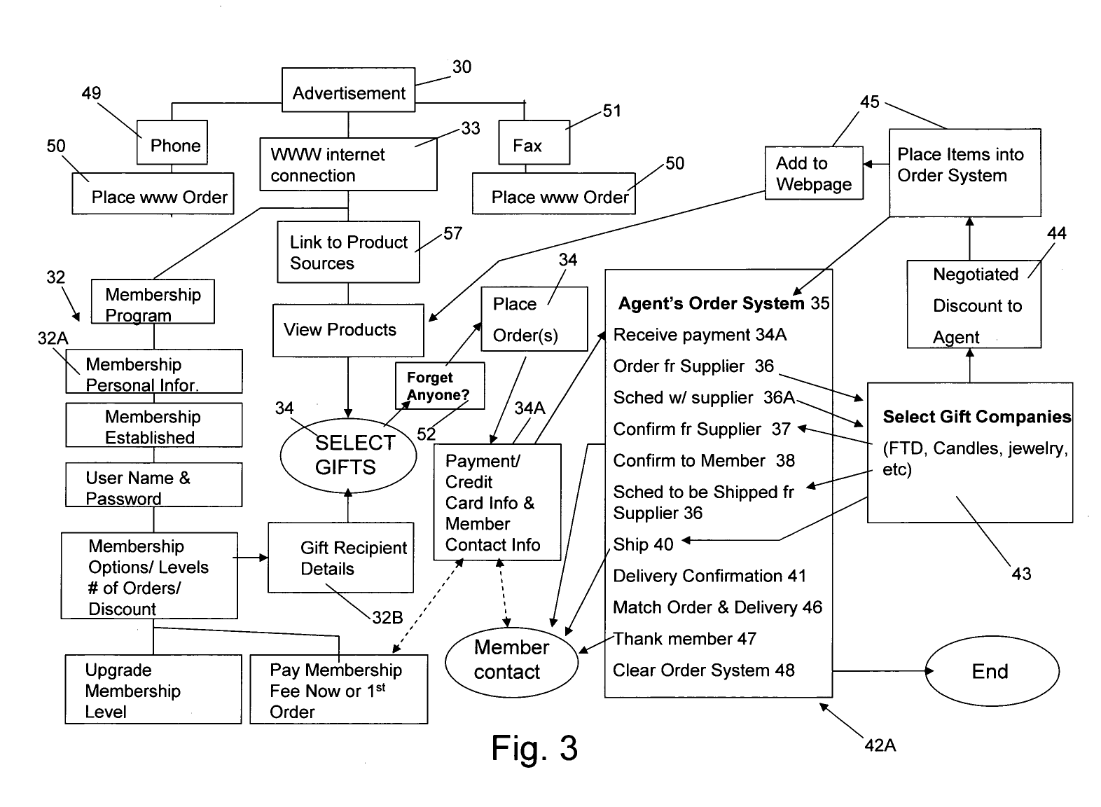

FIG. 3 is a very detailed flow chart of the “Remember Easy” gift system.

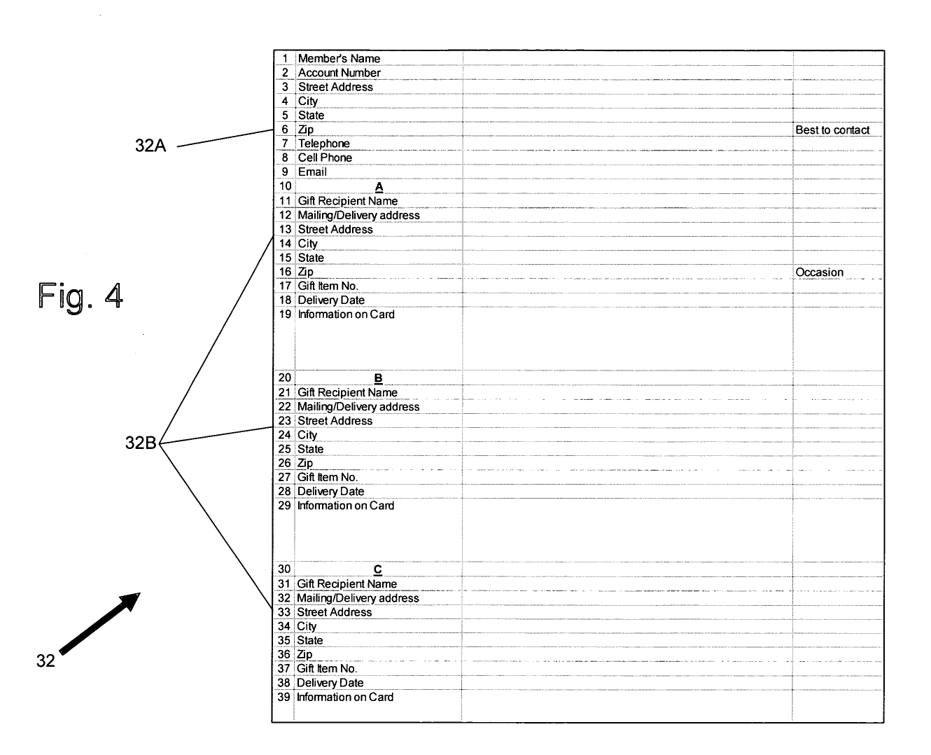

FIG. 4 is a chart used for entering the membership data and recipient details.

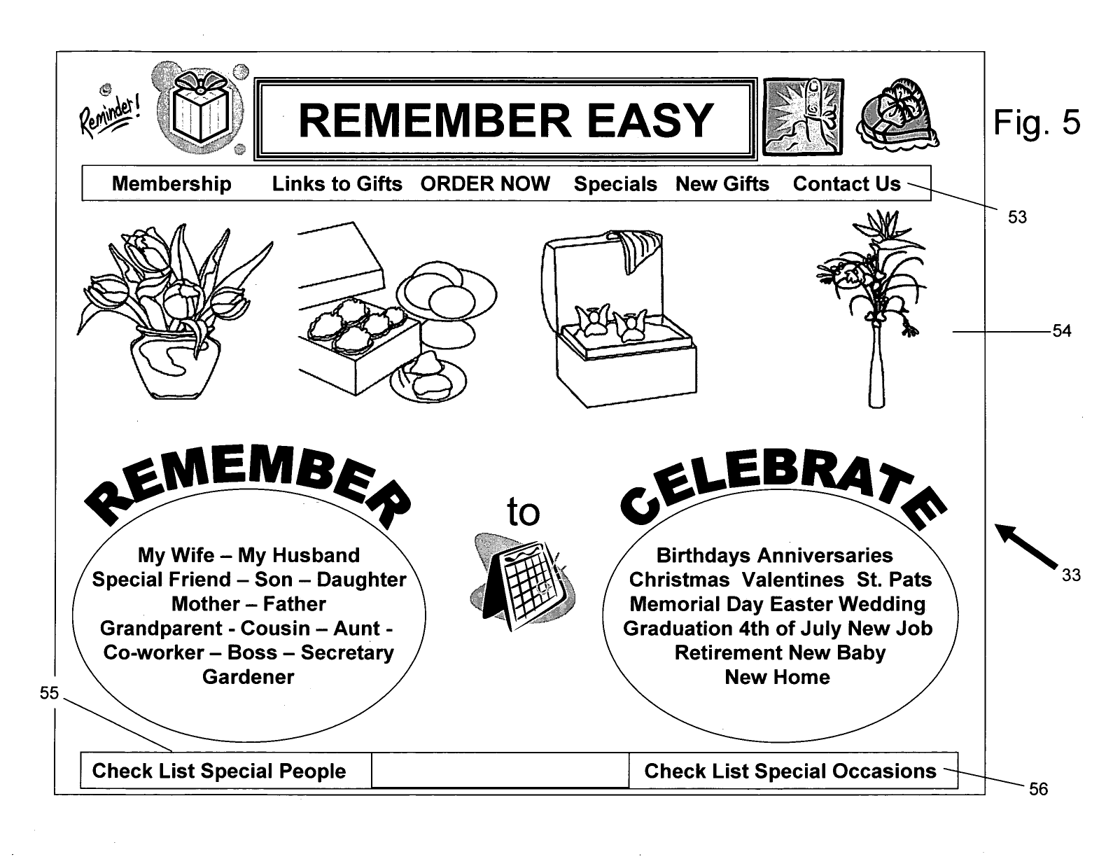

FIG. 5 is an example of a webpage for the new

### Special Occasion Gift Ordering Business Method—“Remember Easy”

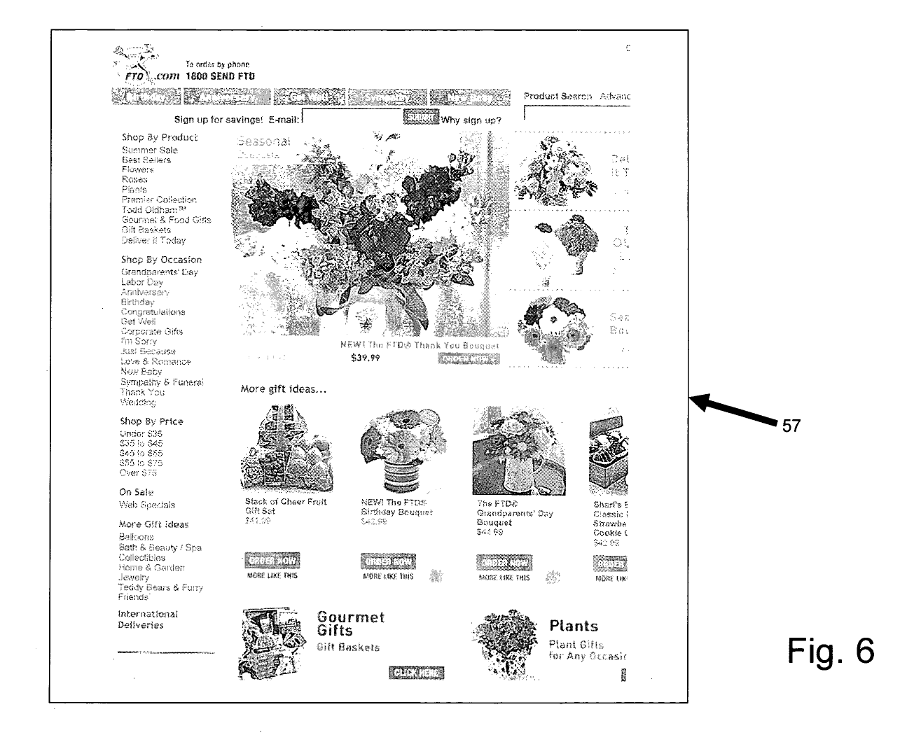

FIG. 6 is an example of potential links to other websites for gift descriptions and ultimate selection.

### DESCRIPTION OF THE DRAWINGS

### Reference Numerals

The following list refers to the accompanying pictures, tables, and drawings:

| Ref # | Description |
|---|---|
| 30 | Advertisement of Method and website |
| 31 | General Simple Flow Chart |
| 32 | Customer/Member Input |
| 32A | Membership Details |
| 32B | Gift Recipient Details |
| 33 | Agent “Remember Easy” website |
| 34 | Order by Customer/member |
| 34A | Payment to Website |
| 34B | Transfer Payment to Order System |
| 35 | Agent “Remember Easy” ordering system |
| 36 | Agent “Remember Easy” schedule order from vendor |
| 37 | Confirmation from vendor to agent “Remember Easy” |
| | order system that gift is scheduled. |
| 38 | Confirmation to customer that order is scheduled |
| 39 | Vendor ordering system |
| 40 | Ship gift to customer's recipient |
| 41 | Confirm delivery by vendor to “Remember Easy” system |
| 42 | Additionally detailed flowchart |
| 42A | More detailed flowchart (than 42) |
| 43 | Select vendor |
| 44 | Negotiate discount from vendor to “Remember Easy” |
| 45 | Add items from vendor to website |
| 46 | Match order details with delivery and payments |
| 47 | Thank member for order and inquire if problems or |
| | concerns |
| 48 | Clear system of to ship - retain member detail for |
| | future years |
| 49 | Phone order (manual) |
| 50 | Enter manual order into system |
| 51 | Fax receipt of order (manual) |
| 52 | Reminder to consider anyone forgotten? |
| 53 | Website menu bar - membership, links to vendors and |
| | item descriptions, order now, specials, new gifts, |
| | contact us |
| 54 | Sample of gifts |
| 55 | Checklist of special occasions |
| 56 | Check list of special people |
| 57 | Vendor's web pages |

### DETAILED DESCRIPTION OF PREFERRED EMBODIMENT

The present invention is a business method that permits a Special Occasion Gift Ordering Business Method—“Remember Easy” in the gift providing industry. The method provides a unique way to provide a “giver/member” a system that is a method of combining a computer assisted implementation of displaying optional gifts, choosing an optional gift group or specific gift, directing the gift to be provided, and then purchasing the gift for future delivery. It also provides a system that takes the selection from the purchaser, receives a payment, schedules a delivery of the gift, and confirms the entire transaction for the purchaser. The method provides a unique and simple way for a purchaser to order a service of providing a product to recognize a special occasion, to order and pay for a said product, to deliver the said product, and to feedback the order and delivery to the purchasing client. The method provides a way to combine various existing systems and websites with a simple, new way to accomplish concrete, useful and tangible results in improvement of the gift providing industry.

The preferred embodiment of the method have several Key parts in the overall system comprising:
1. A “Remember Easy” website.
2. Pre-established gifts and discounts from various gift vendors.
3. An interface (preferably electronic) from the “Remember Easy” operating system and the vendors order system.
4. Inputs from the member as to personal data, gift recipient information, and gift selection.
5. A payment system from the Member to the “Remember Easy” website.
6. Scheduling the gift by “Remember Easy” with the vendor and payment to the vendor.
7. Follow-up exchanges confirming orders, shipment and delivery by the “Remember Easy” operating system and the vendor ordering system.

A person having ordinary skill in the field of ordering items from the internet appreciates the various systems, data inputs, data analysis, and resultant information that may be used to physically permit this business method to be accomplished. The improvement over the existing art is providing a method that interconnects a variety of systems and provides new important inputs from the customer/member, “Remember Easy” system and vendor system in a timely, easy manner.

The improvements over the existing art are providing a business method that:

a. facilitates efficient and timely ordering of gifts by a member/user;

b. removes the fear and consequence of “forgetting” a special occasion;

c. has a beneficial impact to the user having “one-stop-shopping”;

d. secures an order ahead of time and receives a timely payment from the “Remember Easy” commerce exchange system; and

e. permits input by members 24 hours a day, 7 days per week.

There is shown in FIGS. 1-6 and the Tables incorporated herein a complete operative embodiment of the business method facilitated by the Special Occasion Gift Ordering Business Method—“Remember Easy”

In the drawings and illustrations, one notes well that the FIGS. 1-6 demonstrate the configuration and use of a business method for improving the gift ordering efficiency for its members.

The preferred embodiment of the method Special Occasion Gift Ordering Business Method—“Remember Easy” 31 are Key parts and subsystems in the overall system comprising:
1. A “Remember Easy” website 33.
2. Pre-established gifts and discounts from various gift vendors 44.
3. An interface (preferably electronic) from the “Remember Easy” operating system and the vendors order system.
4. Inputs from the member as to personal data, gift recipient information, and gift selection 32.
5. A payment system from the Member to the “Remember Easy” website 34.
6. Scheduling the gift by “Remember Easy” with the vendor and payment to the vendor.
7. Follow-up exchanges confirming orders, shipment and delivery by the “Remember Easy” operating system and the vendor ordering system 35-38, 41.

FIG. 1 is a Simple flowchart 31 of the business method. First, the agent company, Remember Easy, establishes a website 33 and then advertises 30 the benefits and availability of the unique offering and method to give gifts. The various steps include the member data section 32 where the various information about the member is inputted to the order system 35; the payment of a membership fee and the selection of recipients and the gifts 34A. The gift selection 34A results in a customer order 34 that then transfers 34B to the order system 35. A confirmation 38 is fed back to the member. The agent ordering system 35 then contacts 36 the vendor 39 to schedule the gift and receives confirmation 38 that the vendor 39 received the order and scheduled the delivery. At the appointed time the vendor 39 ships the gift 40 and confirmations of delivery 41 and 41A are fed back to the vendor 39 and the ordering system 35. The whole ordering system may be organized and arranged by using a variety of interactive systems that match the financial and production, control, and logistics (PCL) of the order with the interaction with the internet. Other means to contact without using the internet are described below. The computer based system and the interconnections include a myriad of potential configurations. However, the scope and sequence of this remember and schedule system is not dependent on the computer base. Rather, the invention anticipates a plethora of combinations that still achieve the improved gift system described in this specification.

FIG. 2 is a more detailed flowchart 42 showing steps and further details in the business method known as Special Occasion Gift Ordering Business Method—“Remember Easy”. The above steps in the simple flowchart 31 described in FIG. 1 are incorporated by reference. Additional steps include the reference to the vendor and Remember Easy agent selecting the various gifts 43, negotiating discounts 44 and then adding 45 the potential gifts to the website 33. Another nuance is the ability for the order system 35 to interface directly with the gift company/vendor 39 through various E-commerce means. Included are pay transfers and seamless banking from the client's payment to the vendor's receipt of payment less the discount to the Remember Easy Agent. Another expanded feature is a match-up of the delivery and order 46 which enables Remember Easy to clear the order system. The member's records are archived for future use in the following years for convenience as the member continues to use the system.

FIG. 3 is a very detailed flow chart 42A of the “Remember Easy” gift system. In addition to the steps described for the simple flowchart 31 in FIG. 1 and the additional details in flowchart 42 shown in FIG. 2, this chart 42A shows the added steps to further describe the complete Special Occasion Gift Ordering Business Method—“Remember Easy”. Here the effort to recognize and thank members 47 for the order is scheduled in the flowchart 42A. Likewise, the option to telephone 49 or fax 51 and order to the order system 35 is accomplished. Once the telephone 49 or fax 51 order arrives, the order is manually 50 placed in the order system 35. Another important query of the member is to “ask” if any potential gift recipient is missed 52. The website 33 permits the member to view a list of special people 56 and special occasions 55 as described below.

FIG. 4 is a chart used for entering the membership data 32 and recipient details. The membership details 32A and the gift recipient details 32B are self explanatory. However, one skilled in the art of providing access to buy things and to ship them to various places and people well appreciates that this list is exemplary and not limiting to the scope of this business method.

FIG. 5 is an example of a webpage 33 for the new Special Occasion Gift Ordering Business Method—“Remember Easy”. This page is not a limitation to the scope of the business method described for the Special Occasion Gift Ordering Business Method—“Remember Easy”. Features for the website 33 should include a menu bar 53 which includes links to other pages within the website 33. Examples here are a menu bar that links to pages for membership, links to vendors and item descriptions, links to order now, links to specials, links to new gifts, and of course links to contact us for communications and questions. Other contents on the page include a series of special gifts 54, a check list for special occasions 55, and a checklist for special people 56 as described below by tables in the specification for the operations.

FIG. 6 is an example of potential links to other vendor websites 57 for gift descriptions and ultimate selection. The example is a vendor's web page for flower arrangements 57. Many other potential sites may be used to showcase and demonstrate gifts available from the Special Occasion Gift Ordering Business Method—“Remember Easy”.

In total, all the points and details mentioned here throughout this detailed description of the drawings are exemplary and not limiting. Other components specific to describing a business method for Special Occasion Gift Ordering Business Method—“Remember Easy” may be added. A person having ordinary skill in the field of these types of business methods well appreciates this possibility of additions. The drawings and components have been focused on the parts shown in respect to the instant invention.

### Operation of the Preferred Embodiment

The new method for Special Occasion Gift Ordering Business Method—“Remember Easy” has been described in the above embodiment. The manner of how the method operates is described below. Note well that the description above and the operation described here must be taken together to fully illustrate the concept of the new method for Special Occasion Gift Ordering Business Method—“Remember Easy”.

FIG. 1 is a Simple flowchart of the business method. One skilled in ordering systems and web interactive business methods well appreciates that the Special Occasion Gift Ordering Business Method—“Remember Easy” provides a unique and improved method to allow “busy” people to still remember special persons on special occasions by sending gifts and remembrance gestures such as flowers, candy, and the like. The website allows the member to interact and give information about themselves, then list recipients, gifts and dates. They then pay for the gift and service. The Special Occasion Gift Ordering Business—“Remember Easy”, with the order system 35, then coordinates the purchase and timely delivery of the gift through various vendors 39.

Example parts of a typical operating system is shown in the following Table A.

TABLE A
SOME EXAMPLES OF PARTS AND FUNCTIONS OF THE
OPERATING SYSTEM 35.

| Item | Description |
|---|---|
| 1 | Electronic Payment system from Member |
| 2 | Electronic Payment to Vendor |
| 3 | Scheduling system for ordering from Vendor |
| 4 | Automatic matching order from vendor and |
| | scheduled to ship |
| 5 | Automatic System - delivery to Thank you |
| 6 | Tables for volume discounts from vendors |
| 7 | Order entry from website - details |
| 8 | Member profiles and recipient data |
| 9 | Contact Email tied with website |
| 10 | Search engine on website for type of gifts |
| 11 | User name and pass word to access members file |
| | and activity |

To start up the initial system the needed steps are shown in the following Table B.

TABLE B
SIMPLE FLOWCHART OF STARTING THE ORIGINAL
“Remember Easy” SYSTEM 31.

| Step | Description |
|---|---|
| 1. | Establish Remember Easy” website. |
| 2. | Pre-established gifts and discounts from various |
| | gift vendors. |
| 3. | Establish an interface (preferably electronic) |
| | from the “Remember Easy” operating system and |
| | the vendors order system. |
| 4 | Establish a payment system from the Member to |
| | the “Remember Easy” website. |
| 5 | Activate website |
| 6 | Receive inputs from the member as to personal |
| | data, gift recipient information, and gift |
| | selection. |
| 7 | Schedule the gift by “Remember Easy” with the |
| | vendor and payment to the vendor. |
| 8 | Follow-up exchanges confirming orders, shipment |
| | and delivery by the “Remember Easy” operating |
| | system and the vendor ordering system. |
| 9 | Repeat the process multiple times if required |
| | for franchises and the like. |

### One skilled in the art of information exchange appreciates that in Step 6, there are many ways to achieve this interface with the member, including website interface, electronic mail, traditional mail, facsimiles and the like.

Once the Special Occasion Gift Ordering Business System—“Remember Easy” is started, there are several ways to generate the tangible, financial revenue steam. These are shown in Table C.

TABLE C
EXAMPLES OF WAYS TO GENERATE REVENUE

| | Method to Create/Capture | |
|---|---|---|
| Item | Revenue | Comments |
| 1 | Membership fees | Decline with larger |
| | | order volume |
| 2 | Percentage discount from | Varies by volume with |
| | Vendors | vendor and type of |
| | | merchandise (vendor's |
| | | mark-up) |
| 3 | Advertising on website by | |
| | locals | |
| 4 | Time value between receipt | Two edged sword if |
| | of payment and schedule to | vendor cost fluctuates |
| | vendor | |

In FIG. 5, described above, is an example of a webpage 33 for the new Special Occasion Gift Ordering Business Method—“Remember Easy”. Features for the website 33 included a menu bar 53 which includes links to other pages. Other contents on the page include a series of special gifts 54, a check list for special occasions 55, and a checklist for special people 56 as described above in the description are delineated here in Tables. Examples, and not limitations, of items for these checklists 54, 55, and 56 are shown in Table D, Table E and Table F, respectively.

TABLE D
EXAMPLES TYPES OF GIFTS 54 (CHECKLIST)

| | | |
|---|---|---|
| FLOWERS | CANDY | JEWELRY |
| PLANTS | CRYSTAL | WINE |
| CRUISES | SPECIAL VACATION | VEHICLES |
| | GETAWAYS | |
| SPORTING GOODS | CLOTHING | BOOKS |
| MUSIC | THEATER TICKETS | AIRLINE TICKETS |

TABLE E
EXAMPLES OF SPECIAL OCCASIONS 55

| | | |
|---|---|---|
| Birthday | Anniversary | Marriage |
| Graduation | New Job | Christmas |
| Thanksgiving Day | Memorial Day | Fourth of July |
| New Job | Retirement | St. Valentine's Day |
| Easter | Saint Patrick's Day | |

TABLE F
EXAMPLES OF SPECIAL PEOPLE 56 (CHECKLIST)

| | | |
|---|---|---|
| Spouse | Significant Other | Daughter |
| Mother | Father | Co-worker |
| Grandparent | Aunt/Uncle | Son |
| Employee | Boss | New Graduate |
| Newly Married | Special Friend | Cousin |

These uses for the new method for Special Occasion Gift Ordering Business Method—“Remember Easy” are strictly exemplary and not limiting to the myriad of uses for a business method that is such as the present innovation. The Special Occasion Gift Ordering Business Method—“Remember Easy” has been described above in connection with what is presently considered to be the most practical and preferred embodiment of the business method for the gift ordering industry. With this description it is to be understood that Special Occasion Gift Ordering Business Method—“Remember Easy” is not to be limited to the disclosed embodiment. On the contrary, the new method is intended to cover various modifications and equivalent arrangements included within the spirit and scope of the description.

What is claimed as new and desired to be protected by Letters Patent is:

1. A gift ordering system, comprising:
a). a system that has a set of members desiring to buy gifts;
b). a means to show and offer gifts;
c). a means to accept an order and a payment for gifts for the member;
d). a means to deliver the gift at a pre-determined schedule; and
e). a means to confirm to the member the delivery of the gift
whereby the system is used by members to provide meaningful and timely gifts for special occasions to specifically selected recipients.

2. The system according to claim 1 wherein the means to show is a website.

3. The system according to claim 1 wherein the means to accept an order and a payment is by a facsimile.

4. The system according to claim 1 wherein the means to accept an order and a payment is by an electronic mail system.

5. The system according to claim 1 wherein the means to accept an order and a payment is transacting on a website.

6. The system according to claim 1 wherein the means to accept an order and a payment is by the postal system.

7. The system according to claim 1 wherein the means to accept an order and a payment is by telephone.

8. A gift ordering system, comprising:
a). a “Remember Easy” website;
b). a set of pre-established gifts and discounts from various gift vendors;
c). an operating system for “Remember Easy” business;
d). one or more vendor order systems;
e). an interface from the “Remember Easy” operating system and the vendors order system;
f). one or more members;
g). a means for the member to provide various inputs from the member as to personal data, gift recipient information, and gift selection;
h). a means for the member to pay the “Remember Easy” website;
i). a means to schedule a gift by “Remember Easy” with the vendor;
j) a means for “Remember Easy” to pay the vendor; and
k). a means to follow-up with the member as to confirming orders, shipment and delivery by the “Remember Easy” operating system and the vendor ordering system
whereby the system is used by members to provide meaningful and timely gifts for special occasions to specifically selected recipients.

9. A method for establishing a gift ordering system in a controlled manner comprising:
a). STEP 1: Establish a “Remember Easy” website.
b). STEP 2: Pre-establish a set of gifts and discounts from various gift vendors.
c). STEP 3: Establish an interface from the “Remember Easy” operating system and the vendors order system.
d). STEP 4: Establish a payment system from the Member to the “Remember Easy” website.
e). STEP 5: Activate the website
f). STEP 6: Receive inputs from one or more members as to personal data, gift recipient information, and gift selection.
g). STEP 7: Schedule selected gift by “Remember Easy” with the vendor and payment to the vendor.
h). STEP 8: Follow-up exchanges confirming orders, shipment and delivery by the “Remember Easy” operating system and the vendor ordering system.
i). STEP 9: Repeat the process multiple times if required.
